(19) United States
(12) Patent Application Publication
(10) Pub. No.: US 2002/0067833 A1
(43) Pub. Date: Jun. 6, 2002

(54) Method and apparatus for providing conditional access to the source code of a program

(76) Inventors: Ching-Chih (Jason) Han, Fremont, CA (US); Huan-Hui Zhao, Fremont, CA (US); Tsung-Yen (Eric) Chen, Fremont, CA (US); Kuo-Chun Lee, Fremont, CA (US)

Correspondence Address: VICTOR H. OKUMOTO, P.O. BOX 6120, FREMONT, CA, 94538, US

(21) Appl. No.: 09/730,641

(22) Filed: Dec. 5, 2000

(51) Int. Cl. H04L 9/00

(52) U.S. Cl. 380/280

(57) ABSTRACT

A method and apparatus for providing conditional access to the source code of a program are described. An encrypted version of the source code is provided along with a binary executable version of the source code to a recipient. An escrow holder holds a software key for decrypting the encrypting source code, and releases the software key to the recipient only upon satisfaction of a release condition detailed in an escrow agreement executed by the program's vendor and the recipient.

### FIELD OF THE INVENTION

The present invention generally relates to source code escrows and in particular, to a method and apparatus for providing conditional access to the source code of a program.

### BACKGROUND OF THE INVENTION

Software programmers use programming languages such as C++ to write programs in human-readable form commonly referred to as source code. To execute such programs, however, the source code must first be translated into machine-readable form commonly referred to as object code or binary executable code.

Software vendors distribute their programs in object code form, because it is convenient that way for their customers since they do not have to compile the programs first before running them. Also, distributing the programs as object code provides some measure of security for the software vendor against unauthorized copying of their programs since the object code is not readily readable.

Software vendors offer maintenance services to their customers in the form of bug fixes, updates, revisions and enhancements to their programs. Software vendors are interested in providing such maintenance, because it generates an ongoing revenue stream for them. Customers, on the other hand, are interested in receiving such maintenance, because it helps protect their investment in programs. Customers cannot perform their own maintenance, because they to not have access to the source code. Consequently, customers are dependent on software vendors providing such maintenance.

Source code escrows ensure that customers have access to the source code in the event that any one of certain release conditions detailed in an escrow agreement is met. Typically, events such as the software vendor going out of business, the software vendor breaching its contractual obligations to provide maintenance and support, and the software vendor going into receivership or bankruptcy are release conditions. Another release condition might be the software vendor being acquired by a competitor of the customer.

Escrow agreements generally obligate the software vendor to deposit with the escrow agent or holder updated versions of the source code as the program or software is revised in order to ensure that the source code held in escrow is kept current. Since maintenance is an ongoing activity, however, for one reason or another, the software vendor may fail to always keep the most current version of the source code in the escrow. Thus, when the source code is released, because of satisfaction of a release condition, the version released to the customer may be out of date and of limited use. If the release condition is the software vendor's bankruptcy, the customer may have no effective recourse to correct the deficiency.

Software escrows tend to be relatively expensive. The source code is typically held in escrow stored on magnetic media that may be subject to damage without special media vaults, which are maintained at a certain temperature and humidity selected to preserve the integrity of the media. Also, because standard fire extinguishing systems can damage the magnetic media, such media vaults may include special halon gas extinguishing systems or similar alternatives, and expensive fire retention walls. Further, because of the proprietary nature of the source code being held in escrow, extensive security systems are necessary. Also, the escrow holder should maintain adequate insurance coverage in the event that any of these additional security measures should fail. All of these factors add to the operating costs of the source code escrow.

### OBJECTS AND SUMMARY OF THE INVENTION

Accordingly, one object of the present invention is a method for providing conditional access to the source code of a program that is low cost.

Another object of the present invention is a method for providing conditional access to the source code of a program that ensures that the source code being released is always the most recent version.

Yet another object of the present invention is a method for providing conditional access to the source code of a program that eliminates the need for providing information on magnetic media in the escrow, thereby eliminating the concerns regarding deterioration of the magnetic media.

These and additional objects are accomplished by the various aspects of the present invention, wherein briefly stated, one aspect is a method for providing conditional access to the source code of a program, comprising: generating encrypted source code of a program; generating a software key to decrypt the encrypted source code; providing the encrypted source code to a recipient; and providing the software key to an escrow holder under instructions to provide the software key to the recipient pursuant to release conditions.

Another aspect of the invention is an apparatus for providing conditional access to the source code of a program. The apparatus comprises a computer that is programmed to generate encrypted source code of the program, and generate a software key to decrypt the encrypted source code. The computer is further programmed to facilitate the providing or to provide the encrypted source code to a recipient, and to facilitate the providing or to provide the software key to an escrow holder who is under instructions to provide the software key to the recipient pursuant to release conditions.

Another aspect of the invention is a method for providing conditional access to the source code of a program, comprising: receiving source code of a program, and information identifying a recipient; generating encrypted source code from the source code; generating a software key to decrypt the encrypted source code; and creating a record including the software key and the information identifying the recipient.

Another aspect of the invention is an apparatus for providing conditional access to the source code of a program. The apparatus comprises a computer that is programmed to receive source code of a program, and information identifying a recipient; generate encrypted source code from the source code; generate a software key to decrypt the encrypted source code; and create a record including the software key and the information identifying the recipient.

Additional objects, features and advantages of the various aspects of the present invention will become apparent from the following description of its preferred embodiment, which description should be taken in conjunction with the accompanying drawing.

### BRIEF DESCRIPTION OF THE DRAWINGS

FIG. 1 illustrates a flow diagram of a method for providing conditional access to the source code of a program employing a passive escrow holder.

FIG. 2 illustrates an apparatus for providing conditional access to the source code of a program employing a passive escrow holder.

FIG. 3 illustrates an alternative apparatus for providing conditional access to the source code of a program employing a passive escrow holder.

FIG. 4 illustrates an alternative apparatus for providing conditional access to the source code of a program employing a passive escrow holder.

FIG. 5 illustrates an alternative apparatus for providing conditional access to the source code of a program employing a passive escrow holder.

FIG. 6 illustrates a flow diagram of a method for providing conditional access to the source code of a program employing an active escrow holder.

FIG. 7 illustrates an apparatus for providing conditional access to the source code of a program employing an active escrow holder.

### DETAILED DESCRIPTION OF THE PREFERRED EMBODIMENT

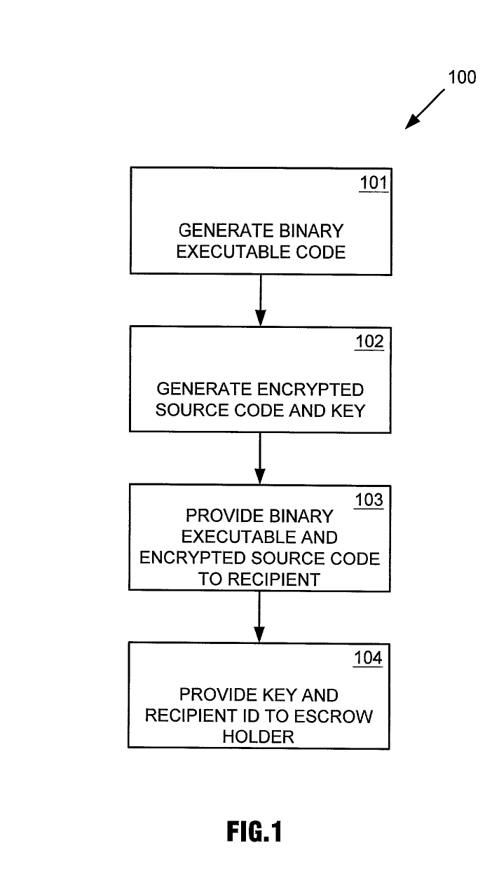

FIG. 1 illustrates a flow diagram of a method 100 for providing conditional access to the source code of a program. The method employs a passive escrow holder or agent. The escrow holder is referred to herein as being passive, because the escrow holder in this case merely holds a software key for release to a beneficiary upon satisfaction of a release condition.

The software vendor substantially controls the method 100. In 101, object or binary executable code is generated by compiling the source code of a program. In 102, encrypted source code is generated by encrypting the source code of the program. Also generated in 102 is a software key to decrypt the encrypted source code. The encryption and software key generation are performed by conventional techniques. Preferably, the software key is randomly or pseudo-randomly generated. As can be readily appreciated, the order in which 101 and 102 are performed is not important.

In 103, the binary executable code and the encrypted source code are provided to a recipient. The recipient may be a customer that has purchased the binary executable code, or a licensee that has licensed the use of the binary executable code. In 104, the software key and information identifying the program, the recipient of the program, and the escrow agreement executed between the software vendor and the recipient are provided to an escrow holder. In one embodiment, such information takes the form of a program identifier and a recipient identifier, from which, the escrow agreement may be determined. In another embodiment, such information takes the form of an escrow agreement identifier, wherein the program and the recipient are identified in the escrow agreement. In either case, the information may be encoded for security reasons, and the escrow holder is under instructions to provide the software key to the recipient upon satisfaction of any one of a number of release conditions detailed in the escrow agreement. As can be readily appreciated, the order in which 103 and 104 are performed is not important.

Since the binary executable code and the encrypted source code are generated from the same version of the source code, there is no problem with the encrypted source code being out of date or being otherwise incompatible with the binary executable code being run by the recipient at any time. The recipient, who is typically a purchaser or licensee of the program, therefore is assured that in the event that a release condition is satisfied, the recipient will have access to the correct version of the source code of the program.

Also, since the software key is generally a series of ASCII characters, it can be stored on a sheet of ordinary paper and handled just like any other important document. On the other hand, even if stored on magnetic media such as a floppy disc or the hard disk of a personal computer, it is a simple matter to have multiple back-up copies of the software key since such information may be easily copied and stored. Further, since the source code itself is not stored in escrow, the extensive security measures used in implementing conventional source code escrows are not necessary.

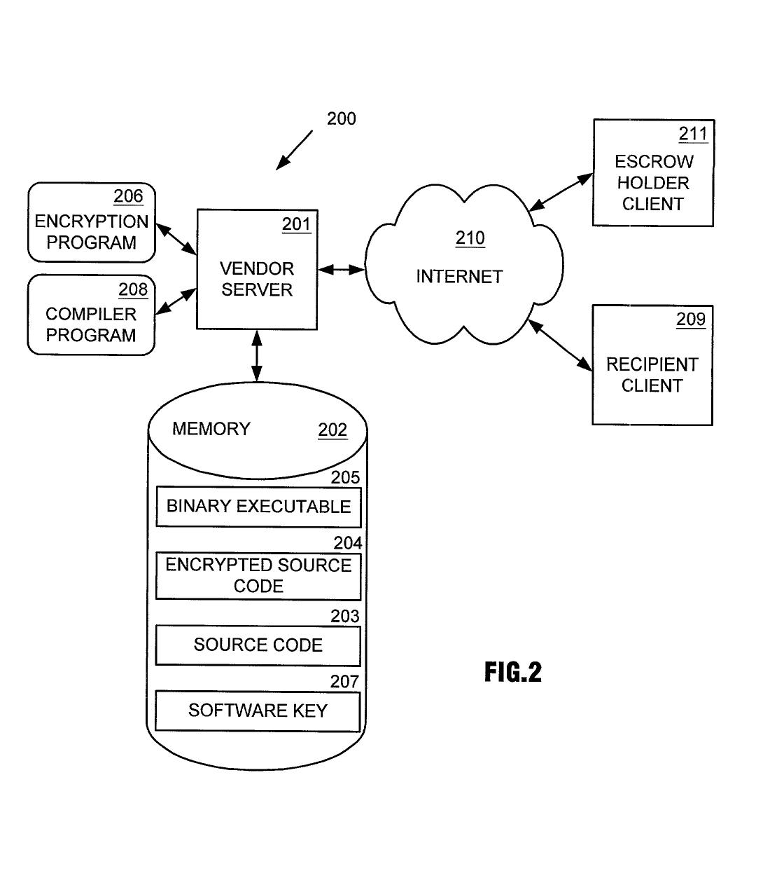

FIG. 2 illustrates an apparatus 200 for providing conditional access to the source code of a program employing a passive escrow holder. The apparatus 200 includes a server 201 operated by a software vendor. The server 201 has a memory device 202 for storing the source code 203, encrypted source code 204, and binary executable code 205. The memory device 202 is typically a mass storage device such as a hard disk. A conventional encryption program 206 executed by the server 201 generates the encrypted source code 204 from the source code 203 and a software key 207 for decrypting the encrypted source code 204 so as to recover the original source code 203. The software key 207 is preferably randomly or pseudo-randomly generated as a string of ASCII characters by the encryption program 206. A conventional compiler program 208 also executed by the server 201 generates the binary executable code 205 from the source code 203.

Both a copy of the binary executable code 205 and a copy of the encrypted source code 204 are provided to the recipient. The recipient, however, cannot easily recover the source code 203 from the binary executable code 205, or easily recover the source code 203 from the encrypted source code 204 without the software key 207. As an additional precautionary measure, the recipient is contractually restricted from attempting to do so. Around the same time that the binary executable code 205 and the encrypted source code 204 are provided to the recipient, a copy of the software key 207 is provided to an escrow holder, along with information identifying the program and intended recipient of the program, such as described in reference to 103 of FIG. 1. The escrow holder holds the copy of the software key 207 in trust until a release condition as defined in the escrow agreement is satisfied. After being notified that a release condition has been satisfied, the escrow holder releases the copy of the software key 207 to the recipient according to instructions in the escrow agreement.

In the example depicted in FIG. 2, copies of the binary executable code 205 and encrypted source code 204 are provided by the vendor's server computer 201 to the recipient's client computer 209 over the Internet 210 in a conventional client-server transaction using the file transfer protocol. The copy of the software key 207, on the other hand, is provided by the vendor's server computer 201 to an escrow holder's client computer 211 over the Internet 210 in a conventional email transaction, along with information identifying the program, the recipient of the program, and the escrow agreement executed between the software vendor and the recipient. Preferably, such transmissions over the Internet 210 are performed in a secure manner using conventional encryption techniques.

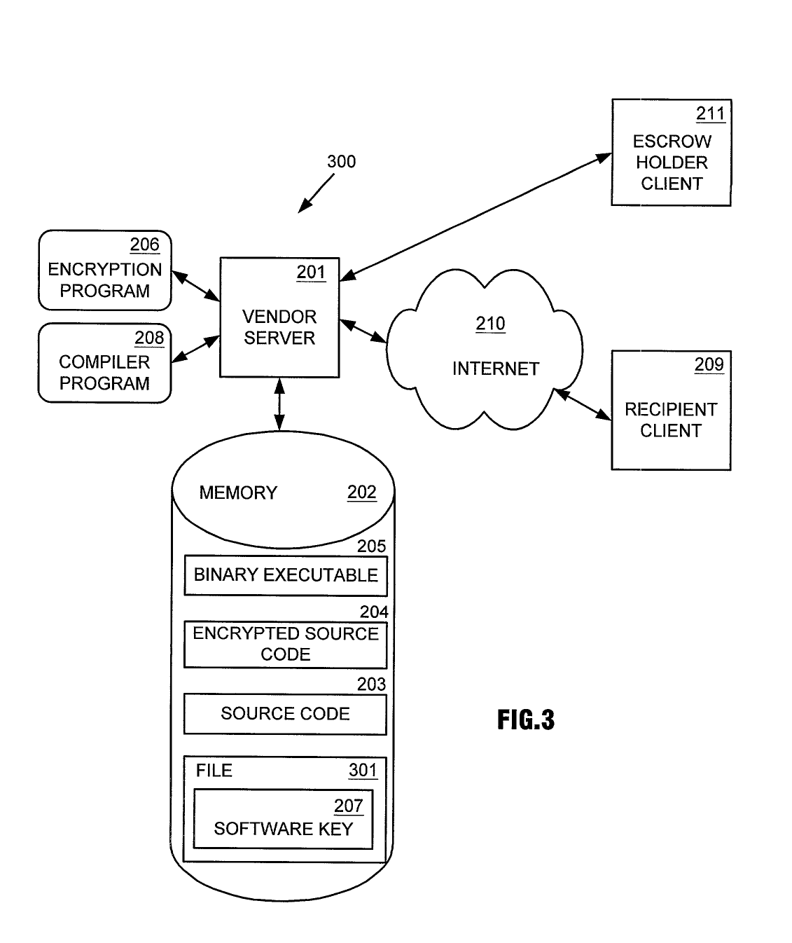

FIG. 3 illustrates an alternative apparatus 300 for providing conditional access to the source code of a program employing a passive escrow holder. In this example, a copy of the software key 207 along with information identifying the program and recipient are provided to the escrow holder in a file 301. The file 301 may be an electronic file transmitted over a conventional direct-line between the vendor's server computer 201 and the escrow holder's client computer 211, or it may be a paper report transmitted in a conventional manner by mail or facsimile transmission. The file 301 may also be transmitted by conventional email over the Internet. In addition to the copy of the software key 207 and information identifying the program, recipient and escrow agreement, copies of other software keys corresponding to other transactions with other recipients are also included in the file 301 so that, for example, each time a new version or update of the program is released, a list of all software keys generated for all recipients of the updates are included in the file 301 along with corresponding program, recipient and escrow agreement information. The structure and the operation of the alternative apparatus 300 are otherwise essentially the same as described in reference to FIG. 2.

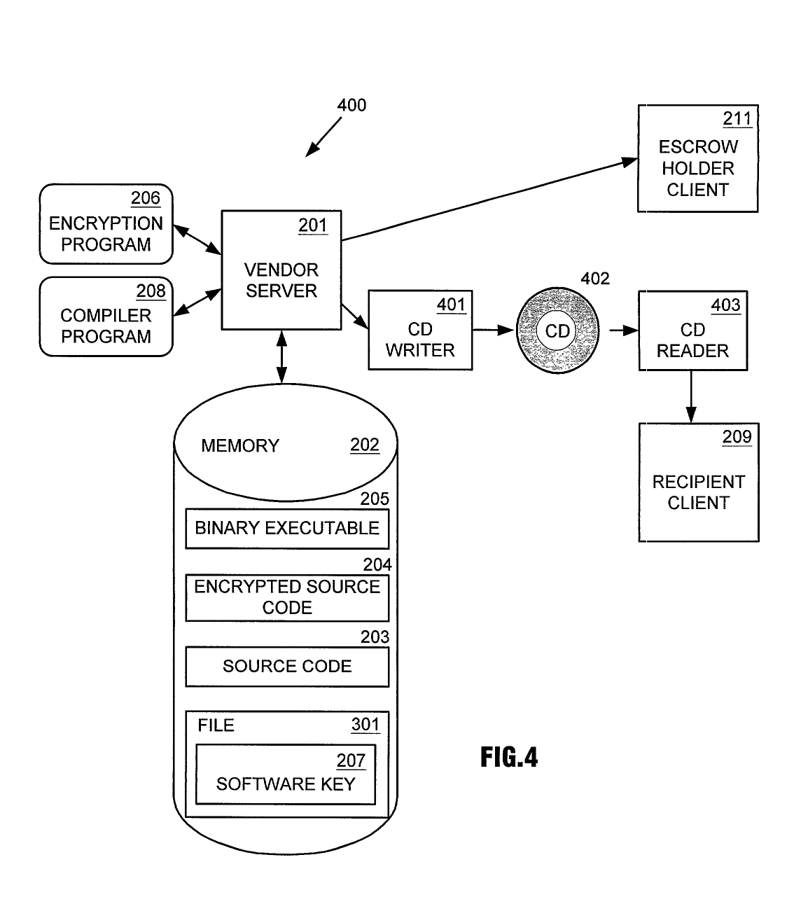

FIG. 4 illustrates an alternative apparatus 400 for providing conditional access to the source code of a program employing a passive escrow holder. In this example, copies of the binary executable code 205 and encrypted source code 204 are provided to the recipient on a computer readable medium such as compact disc 402. A compact disc writer 401 coupled to the vendor's server computer 201 writes the copies of the binary executable code 205 and encrypted source code 204 on the compact disc 402, and a compact disc reader 403 coupled to the recipient's client computer 209 reads them from the compact disc 402. The structure and operation of the alternative apparatus 400 are otherwise essentially the same as described in reference to FIG. 3.

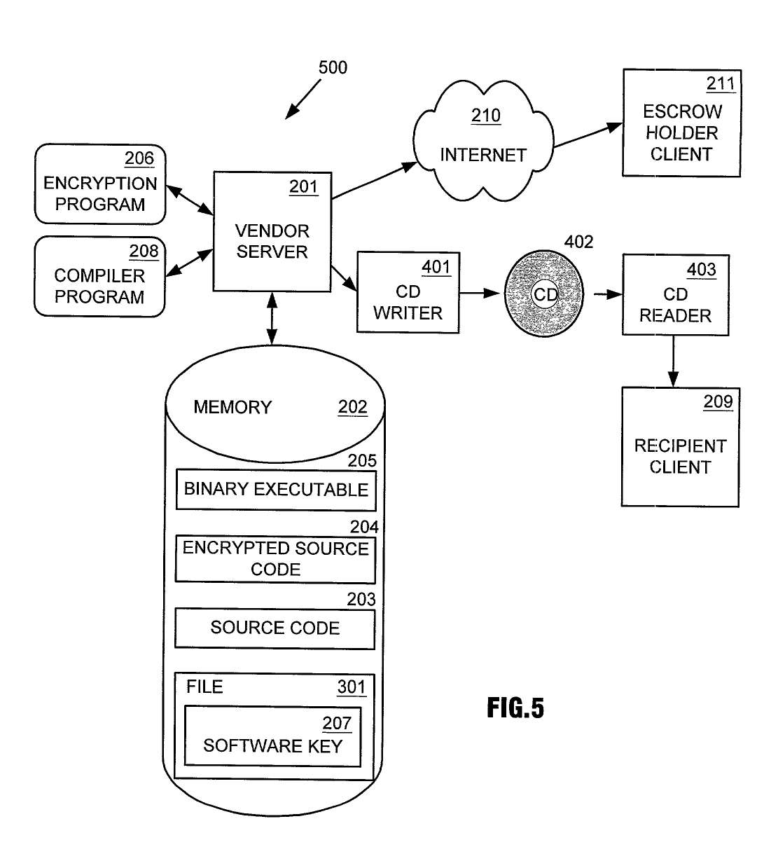

FIG. 5 illustrates an alternative apparatus 500 for providing conditional access to the source code of a program employing a passive escrow holder. In this example, copies of the binary executable code 205 and encrypted source code 204 are provided to the recipient on a computer readable medium such as compact disc 402, as described in reference to FIG. 4. The file 301, however, is transmitted over the Internet 210 as an attachment to an email communication to the escrow holder's client computer 211. The structure and operation of the alternative apparatus 500 are otherwise essentially the same as described in reference to FIG. 4.

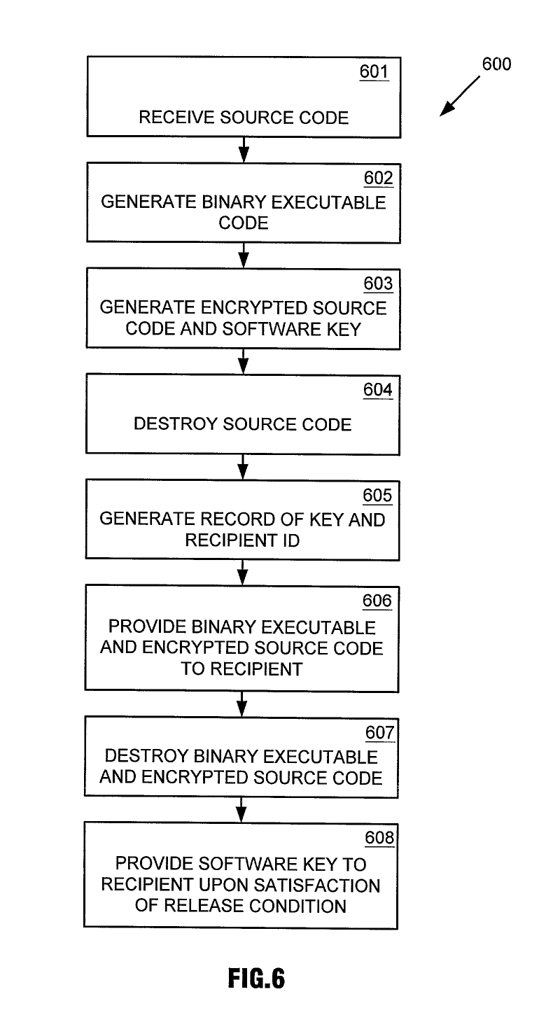

FIG. 6 illustrates a flow diagram of a method 600 for providing conditional access to the source code of a program employing an active escrow holder. The escrow holder is referred to as being active, because the escrow holder in this case does more than merely holding a software key for release to a beneficiary upon satisfaction of a release condition. In this case, the escrow holder substantially controls the method 600.

In 601, a copy of the source code of a program is received from the software vendor. In addition to the source code, information identifying the program, an intended recipient of the program, and the escrow agreement executed between the software vendor and the recipient are preferably also received. In one embodiment, such information takes the form of a program identifier and a recipient identifier, from which, the escrow agreement may be determined. In another embodiment, such information takes the form of an escrow agreement identifier, wherein the program and the recipient are identified in the escrow agreement.

In 602, binary executable code is generated by compiling the source code. In 603, encrypted source code is generated by encrypting the source code. Also generated along with the encrypted source code is a software key to decrypt the encrypted source code. The source code encryption and software key generation are performed by conventional techniques. Preferably, the software key is randomly or pseudo-randomly generated. As can be readily appreciated, the order in which 602 and 603 are performed is not important. In 604, the source code is destroyed after performing 602 and 603 for security reasons since it is no longer necessary.

In 605, a record of the software key is generated along with the information identifying the program and the intended recipient of the program. The record may be in the form of a paper document, electronic file or computer database. For precautionary purposes, backups of the record are created and stored in safe locations. In 606, the binary executable code and the encrypted source code are provided to the recipient. As can be readily appreciated, the order in which 605 and 606 are performed is not important. In 607, the binary executable code and the encrypted source code are destroyed after 606 for security reasons since they no longer are necessary. The escrow holder is under instructions to provide the software key to the recipient pursuant to release conditions detailed in the escrow agreement. In 608, the software key is thereupon provided to the recipient upon satisfaction of one of the release conditions.

As in the example described in reference to FIG. 6, the binary executable code and the encrypted source code are generated from the same version of the source code. Therefore, there is no problem with the encrypted source code being out of date or being otherwise incompatible with the binary executable code being run by the recipient at any time. The recipient is therefore assured that in the event that a release condition is satisfied, the recipient will have access to the correct version of the source code of the program.

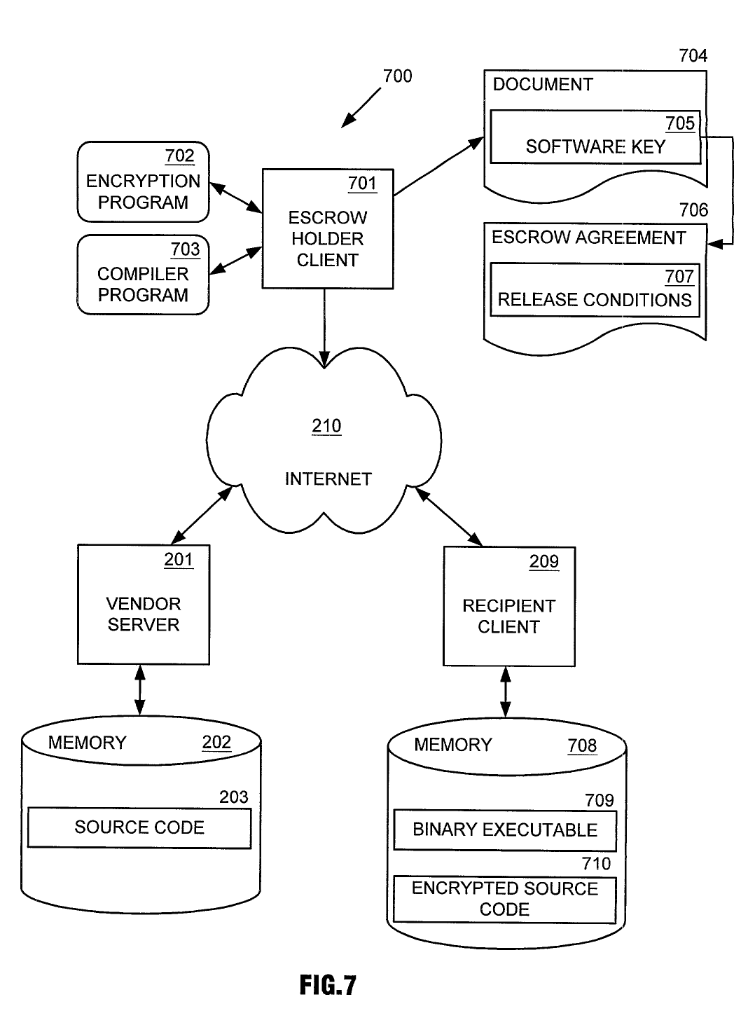

FIG. 7 illustrates, as an example, an apparatus 700 performing the method 600 for providing conditional access to the source code of a program employing an active escrow holder. The apparatus 700 includes a client computer 701 operated by the escrow holder. The computer 701 generates a document, file or database 704 including a record 705 including a software key and information identifying a program, recipient and an escrow agreement 706 corresponding to the software key. The escrow agreement 706 is executed by the program's software vendor and the recipient, and entitles the recipient to receive the software key upon satisfaction of one of the release conditions 707 included in the escrow agreement 706. The computer 701 has an encryption program 702, such as described in reference to 206 in FIG. 2, for generating encrypted source code from the source code of the program, and generating a software key for decrypting the encrypted source code so as to recover the original source code. The computer 701 also has a compiler program 703, such as described in reference to 208 in FIG. 2, for generating binary executable code from the source code.

In performing 601, the client computer 701 receives a copy of source code 203 from the vendor's server 201, via, for example, the Internet 210. In performing 602, the client computer 701 runs the compiler program 703 to generate binary executable code from the copy of the source code 203. In performing 603, the client computer 701 runs the encryption program 702 to generate encrypted source code and a software key. In performing 604, the client computer 701 preferably destroys the copy of the source code 203 for security reasons. In performing 605, the client computer 701 generates a record 705 including the software key and information identifying the program, recipient and escrow agreement corresponding to the software key. The record 705 is created, for example, in document 704, and identifies the escrow agreement 706, as indicated by the arrow in FIG. 7 going from the record 705 to the escrow agreement 706. In performing 606, the client computer 701 provides the generated binary executable code and encrypted source code to the recipient's client computer 209, via, for example, the Internet 210. The recipient's client computer 209 has a memory 708 for storing the received binary executable code 709 and encrypted source code 710. Preferably, the memory 708 is a mass storage device such as a hard disk. In performing 607, the client computer 701 preferably destroys its copy of the binary executable code and encrypted source code for security purposes. Thereafter, upon notification of a release condition being satisfied, in performing 608, the client computer 701 transmits a copy of the software key stored in record 705 to the recipient's client computer 209 by a secure email transmission over the Internet 210.

Although the various aspects of the present invention have been described with respect to a preferred embodiment, it will be understood that the invention is entitled to full protection within the full scope of the appended claims.

We claim:

1. A method for providing conditional access to the source code of a program, comprising:
generating encrypted source code of a program;
generating a software key to decrypt said encrypted source code;
providing said encrypted source code to a recipient; and
providing said software key to an escrow holder who is under instructions to provide said software key to said recipient upon satisfaction of a release condition.

2. The method according to claim 1, wherein said software key is randomly generated while generating said encrypted source code.

3. The method according to claim 1, further comprising generating binary executable code of said program, and providing said encrypted source code and said binary executable code of said program to said recipient.

4. The method according to claim 3, wherein said providing of said encrypted source code and said binary executable code to said recipient is performed over the Internet using file transfer protocol.

5. The method according to claim 4, wherein said providing of said software key to said escrow holder includes transferring information of said software key along with an identification of said recipient to said escrow holder.

6. The method according to claim 4, wherein said providing of said software key to said escrow holder includes emailing said software key to said escrow holder.

7. The method according to claim 6, wherein said providing of said software key to said escrow holder further includes emailing information identifying said recipient along with said software key to said escrow holder.

8. The method according to claim 3, further comprising writing said encrypted source code and said binary executable code on a computer readable medium, and said providing of said encrypted source code and said binary executable code to said recipient is performed by providing said computer readable medium to said recipient.

9. The method according to claim 8, wherein said providing of said software key to said escrow holder includes transferring information of said software key along with information identifying said recipient to said escrow holder.

10. An apparatus for providing conditional access to the source code of a program, comprising a computer that is programmed to generate encrypted source code of the program, generate a software key to decrypt said encrypted source code, provide said encrypted source code to a recipient, and provide said software key to an escrow holder who is under instructions to provide said software key to said recipient upon satisfaction of a release condition.

11. The apparatus according to claim 10, wherein said computer is further instructed to electronically transfer said encrypted source code along with binary executable code of said program to said recipient.

12. The apparatus according to claim 11, wherein said computer is further instructed to electronically transfer said software key along with information identifying said recipient to said escrow holder.

13. An apparatus for providing conditional access to the source code of a program, comprising a computer that is programmed to generate encrypted source code of the program, generate a software key to decrypt said encrypted source code, facilitate providing said encrypted source code to a recipient, and facilitate providing of said software key to an escrow holder who is under instructions to provide said software key to said recipient upon satisfaction of a release condition.

14. The apparatus according to claim 13, wherein said computer is further instructed to write binary executable code of said program and said encrypted source code on a computer readable medium to facilitate providing said binary executable code and said encrypted source code to said recipient.

15. The apparatus according to claim 14, wherein said computer is further instructed to store said software key and information identifying said recipient in a file to facilitate providing said software key and said information identifying said recipient to said escrow holder.

16. A method for providing conditional access to the source code of a program, comprising:
receiving source code of a program, and information identifying a recipient;
generating encrypted source code from said source code;
generating a software key to decrypt said encrypted source code; and
creating a record including said software key and said information identifying said recipient.

17. The method according to claim 16, further comprising providing said encrypted source code to said recipient.

18. The method according to claim 16, further comprising:
generating binary executable code from said source code; and
providing said binary executable code and said encrypted source code to said recipient.

19. The method according to claim 16, further comprising receiving information identifying an escrow agreement having release conditions, and said created record further includes said information identifying said escrow agreement.

20. The method according to claim 19, further comprising providing said software key to said recipient upon satisfaction of one of said release conditions.

21. An apparatus for providing conditional access to the source code of a program, comprising a computer that is programmed to receiving source code of a program, and information identifying a recipient; generate encrypted source code from said source code; generate a software key to decrypt said encrypted source code; and create a record including said software key and said information identifying said recipient.

22. The apparatus according to claim 21, wherein said computer is further instructed to provide said encrypted source code to said recipient.

23. The apparatus according to claim 21, wherein said computer is further programmed to generate binary executable code from said source code, and provide said binary executable code and said encrypted source code to said recipient.

24. The apparatus according to claim 21, wherein said computer is further programmed to receive information identifying an escrow agreement having release conditions, and create said record so as to further include said information identifying said escrow agreement.

25. The apparatus according to claim 24, wherein said computer is employed to provide said software key to said recipient after one of said release conditions has been satisfied.
